(19) United States
(12) Patent Application Publication
(10) Pub. No.: US 2007/0035798 A1
(43) Pub. Date: Feb. 15, 2007

(54) Apparatus and method to compensate for the non-linear movement of an oscillating mirror in a display or printer

(76) Inventor: Eric Gregory Oettinger, Rochester, MN (US)

Correspondence Address: TEXAS INSTRUMENTS INCORPORATED, P O BOX 655474, M/S 3999, DALLAS, TX, 75265, US

(21) Appl. No.: 11/201,645

(22) Filed: Aug. 11, 2005

(51) Int. Cl. G02B 26/08

(52) U.S. Cl. 359/213; 359/900

(57) ABSTRACT

A method of improving the quality of a scanning mirror based imaging system such as a printer or a display system by increasing the laser duty cycle, according to a first embodiment by adjusting the intensity parameter of the received video signals as a function of the velocity of the mirrors. The image quality may be further improved by scaling the output rate of the pixel clocking signal as a function of the sinusoidal motion of the oscillating mirror.

### TECHNICAL FIELD

The present invention relates to video display systems comprising a high speed resonant scanning mirror for generating scan lines, and a low frequency mirror operating substantially orthogonal to the high speed mirror for positioning each of the scan lines to produce an image. The invention also relates to printers comprising a high speed resonant scanning mirror. More particularly, the present invention relates to methods for compensating for the non-linear sinusoidal motion of the oscillating mirrors so that an increased portion of the non-linear sinusoidal motion can be used to generate the image.

### BACKGROUND

In recent years torsional hinged high frequency mirrors (and especially resonant high frequency mirrors) have made significant inroads as a replacement for spinning polygon mirrors as the drive engine for laser printers. These torsional hinged high speed resonant mirrors are less expensive and require less energy or drive power than the earlier polygon mirrors.

As a result of the observed advantages of using the torsional hinged mirrors in high speed printers, interest has also developed concerning the possibility of using a similar mirror system for video displays that are generated by scan lines on a display surface similar to the scan lines of a printer.

Standard CRT (cathode ray tube) video systems for displaying such scan-line signals use a low frequency positioning circuit, which synchronizes the display frame rate with an incoming video signal, and a high frequency drive circuit, which generates the individual image lines (scan lines) of the video. In the prior art systems, the high speed circuit operates at a frequency that is an even multiple of the frequency of the low speed drive and this relationship simplifies the task of synchronization. Therefore, it would appear that a very simple corresponding torsional hinged mirror system would use a first high speed scanning mirror to generate scan lines and a second slower torsional hinged mirror to provide the orthogonal motion necessary to position or space the scan lines to produce a raster “scan” similar to the raster scan of the electron beam of a CRT. Unfortunately, the problem is more complex than that. The scanning motion of a high speed resonant scanning mirror cannot simply be selected to have a frequency that is an even multiple of the positioning motion of the low frequency mirror. Furthermore, the non-linear sinusoidal motion of the resonant scanning mirror restricts the portions of the mirror travel that can be used for a display or for printing.

For example, in order to maximize the size and brightness of the generated image, it is necessary to use as much of the mirror travel as possible. This is because brightness will be improved due to the higher duty cycle of the modulated laser beam, and image size will be increased due to the increased sweep or angular travel of the mirror that could be used. Unfortunately, if a larger portion of the mirror travel is used, the portions of the image at the edges of the image (i.e. portions of the image generated near the peaks or turn around portions of the sinusoidal travel or motion) will deviate significantly from what a linear drive would generate. The image generated by this non-linear drive results in unacceptable distortion and artifacts in the display or image. For example, the image will be compressed at the borders because the mirror travel is slowing to a complete stop, and therefore, the arriving periodic clocked pixels or scan lines are positioned closer and closer together. In addition, and for the same reasons, since the pixels or scan lines are closer together, the amount of illumination per square unit also significantly increases. Therefore, the image also appears to have a halo or frame of light around the edges or border.

Therefore, a mirror based video system that overcomes the above mentioned problems would be advantageous.

### SUMMARY OF THE INVENTION

These and other problems are generally solved or circumvented, and technical advantages are generally achieved by the embodiments of the present invention, which provide a method of using a greater portion of an oscillating mirror to produce an image by a printer, or on a mirror display system from incoming signals. Although particularly suitable for use with high speed oscillating (including resonant) mirrors, some embodiments of the invention are also advantageously used with slow speed oscillating positioning mirrors. More specifically, the method comprises the steps of directing a modulated beam of light toward a scanning mirror that is oscillating at a selected or known frequency. The beam is modulated by signals that represent scan or image lines of an image. The signals comprise the parameters of a series of pixels including a pixel parameter that controls the intensity of the pixel. To eliminate or decrease the halo or light frame effect at the edges of the image that results from using a larger portion of the scanning mirror, the intensity parameter of each pixel is adjusted as a function of the angular velocity of at least one of the oscillating mirrors, and temporarily stored or buffered until required. The series of stored signals including signals with an adjusted intensity parameter are then clocked out to modulate the beam of light directed towards the mirror so as to form an image.

According to another embodiment, the rate of the clock that clocks out the pixel signals is varied or scaled as a function of the sinusoidal motion of the oscillating mirror to eliminate or reduce the compression at the edges of the image. This embodiment is not applicable to the slow speed positioning mirror since each scan or image line is synchronized with the incoming data.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1A and 1B illustrate, respectively, low speed (scan line positioning) and high speed (resonant scanning) cyclic signals for driving the mirrors about their axis;

FIG. 1C is the same as FIG. 1A, except a triangular low speed drive signal is illustrated rather than a sinusoidal drive signal;

FIG. 2A illustrates an image frame generated by a torsional hinged mirror operating at resonant frequency and wherein the linear portion of the mirror travel is used;

FIG. 2B illustrates how the edges of an image will be compressed and/or have increased brightness if increased portions of the sinusoidal motion are used for the display;

FIGS. 3A and 3B are simplified diagrams illustrating a torsional hinged mirror based display system using two single axis mirrors;

FIG. 3C is a simplified diagram illustrating another embodiment comprising a single dual axis mirror in place of the two single axis mirrors;

FIG. 4 is a block diagram of circuitry to compensate for the non-linear motion of the resonant scanning mirror; and

FIG. 5 is a prior art figure showing displays of video frame high frequency where the scan mirror operates at an even multiple of the low frequency positioning mirror.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Referring now to the prior art FIG. 5, there is illustrated the interaction of a high speed horizontal scanning drive signal (scan lines) and a low speed (vertical) or scan line positioning signal. The terms “horizontal”, used with respect to scanning drive signals, and “vertical”, used with respect to the beam positioning signals, are for convenience and explanation purposes only, and it will be appreciated by those skilled in the art that the scan lines could run vertical and the positioning signals could position the vertical scan lines horizontally across a display screen.

As shown in the prior art FIG. 5, four typical frames of video such as indicated by image boxes 10a, 10b, 10c, and 10d are generated during the same (substantially linear) portion of each cycle of the slow speed sinusoidal drive signal represented by curve 12. The location of the image boxes 10a through 10d in FIG. 5 on curve 12 represent the period of time the horizontal scan lines are used to produce an image. More specifically, if the slow speed positioning signal has a frequency of 60 Hz, then in the example of FIG. 5, sixty different frames of video (i.e. complete images), rather than the four as illustrated, will be generated in one second. Therefore, as shown in the figure, and assuming proper synchronization, each successive video frame will start and be located at the same position on a display screen. For example, if transition point 14 represents both the end point of each cycle of the positioning slow speed drive signal and the start point of the next cycle of the drive signal, then a point 16 can be selected to always occur at a certain time period thereafter. This point 16 can, therefore, also be selected as the start point (or placement of the first image pixel) of each frame. Likewise, point 18 will be the end point (or placement of the last pixel) of each frame. In the prior art example of FIG. 5, the portion of the drive signal between points 16 and 18 is substantially linear and is referred to hereinafter as the display portion of the slow speed drive signal, whereas the transition point 14 and the reverse point 20 not only are not located during a linear portion of the signal, but as mentioned, represent where the positioning drive signal actually stops and reverses the direction of the electron beam or mirror. These reverse or “turn-around” portions (above line 22 and below line 24) of the drive signal are referred to hereinafter as the upper and lower peak portions or transition points of the drive signal.

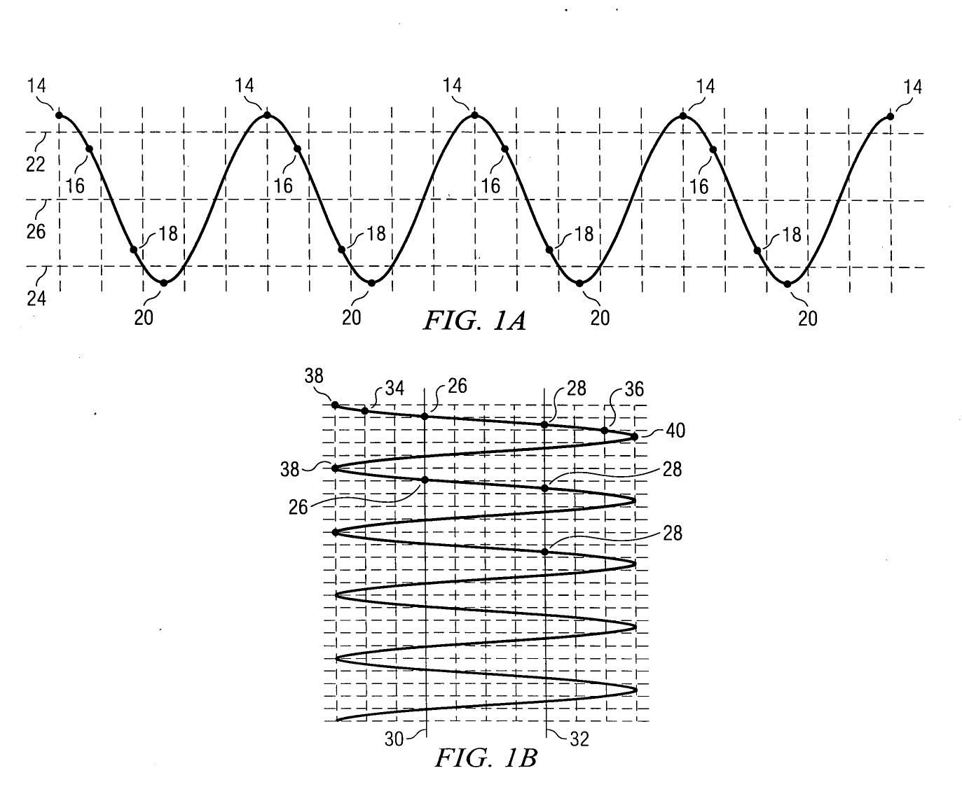

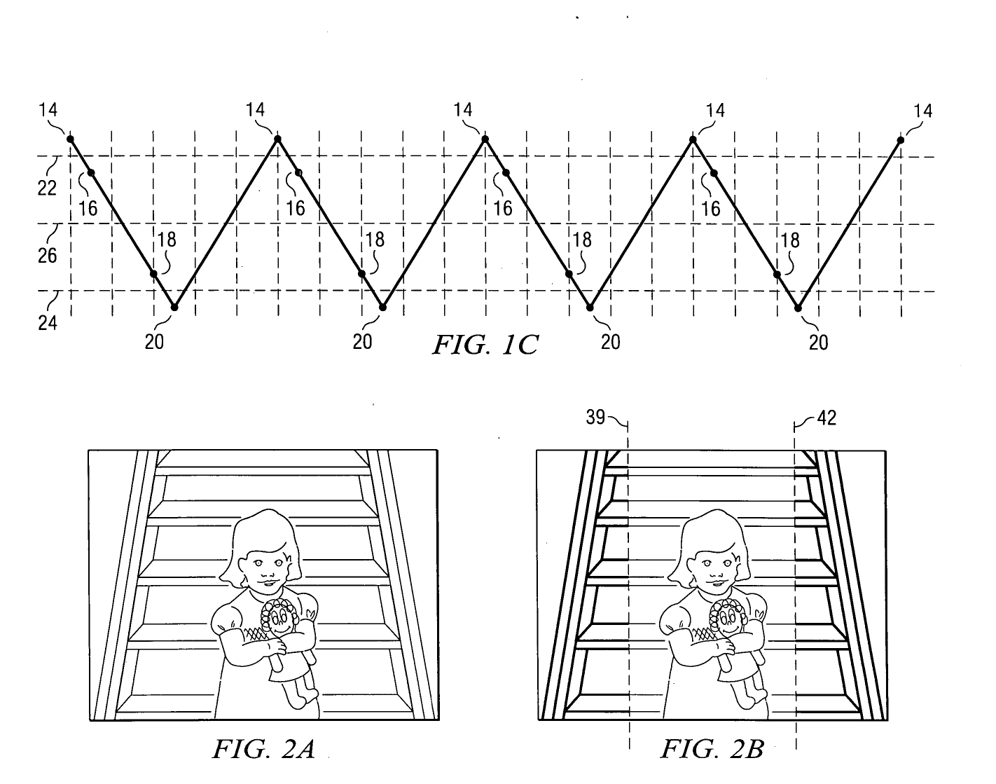

FIG. 1A is similar to FIG. 5 and represents the mirror position or slow speed mirror drive signal for moving the slow speed (positioning) mirror, but does not include the representations of a printed page or the frames of video display 10a through 10d. FIG. 1B represents the high speed or scanning beam drive signal and/or the corresponding scanning position of a high speed oscillating mirror according to the teachings of the present invention, but is not to scale with respect to FIG. 1A. As an example, whereas the slow speed or positioning mirror may oscillate at a frequency of about 60 Hz, the resonant frequency of a scanning torsional hinged mirror, such as illustrated in FIG. 1B, may be on the order of 20 kHz or greater.

FIG. 1C is similar to FIG. 1A, and illustrates that the slow speed cyclic drive signal may be different than a sinusoidal signal, including a repetitive triangular shape. The portion of the curve 12 above and below lines 22 and 24 respectively still represent the upper and lower peak (or turn-around) portions of the mirror movement, and the portion of the curve between lines 22 and 24 still represent the display portion of the signal and/or mirror movement where the video frame is generated.

It will be appreciated by those skilled in the art, that the sinusoidal motion of an oscillating mirror causes various issues or difficulties. It should also be understood that although the invention is applicable to both visual displays and laser printers, a low speed or positioning mirror is not typically present in a laser printer. The orthogonal motion that spaces the scan lines is achieved in a printer by movement of a light sensitive medium such as a rotating drum. Referring again to FIGS. 1A and 1B, there is illustrated the sinusoidal travel motion and/or the drive signal of the oscillating mirrors. The oscillations of the oscillating mirrors may be substantially any speed or frequency, including resonant oscillations at about 20 kHz or greater for the high speed scanning mirror. As was discussed above, some of the embodiments of the present invention are applicable to the slow speed positioning mirror. However, since the high speed scanning mirror particularly benefits from the invention, the following discussion is in respect to a high speed scanning mirror.

Also, as was discussed, ideally the scan lines that are stacked together to form an image are generated in a portion of the movement of the scanning mirror that is substantially linear. That is, the velocity of the mirror movement is substantially constant. Therefore, as an example, to generate a substantially undistorted image such as illustrated in FIG. 2A, the signals representing each pixel of a scan line would be clocked into the system to modulate the moving beam only between points 26 and 28 on the sinusoidal wave of FIG. 1B representing the high speed scanning motion of the light beam. However, if only the portion of travel between points 26 and 28 is used, then only about 40% of the possible sweep distance across a display in one direction is used. Further in the embodiment illustrated in FIG. 1B, the reverse sweep or movement of the beam is not used at all so less than 20% of a complete sweep cycle is used. Therefore, the modulated laser light beam will be on for less than a 20% duty cycle, which results in a dim display. This means that the first pixel or left edge of each scan or image line is at line 30 as shown, and the last pixel or right edge of the scan or image line is at line 32. Therefore, as discussed above, only 40% of the possible beam sweep is used in one direction. It will be appreciated that if the modulated pixels could be distributed over a larger portion of the sinusoidal beam sweep, then the image brightness could be increased and a smaller overall beam sweep would be required for the same image width. As an example only, if the pixels or modulated light beam could begin at point 34 instead of point 26, and end at point 36 rather than point 28, the amount of the beam travel being used would be double. Unfortunately, because the light beam is slowing down (the light beam comes to a complete stop and reverses directions at points 38 and 40), the periodic provided modulated pixels will be displayed closer and closer together as they approach points 34 and 36. As shown in FIG. 2B, this non-linear distribution of pixels results in compression of the image at the edges 39 and 41, and also increases the light intensity at the edges. This increase in light intensity causes a halo effect or frame of light at the edges 39 and 41. Further, for the same reasons since the positioning mirror velocity is also sinusoidal, the spacing between individual scan lines is also compressed at the top and bottom of an image (not shown) with a corresponding increase in intensity. Therefore, if a larger portion of the resonant mirror movement is to be used, these unacceptable effects must be eliminated, or significantly improved.

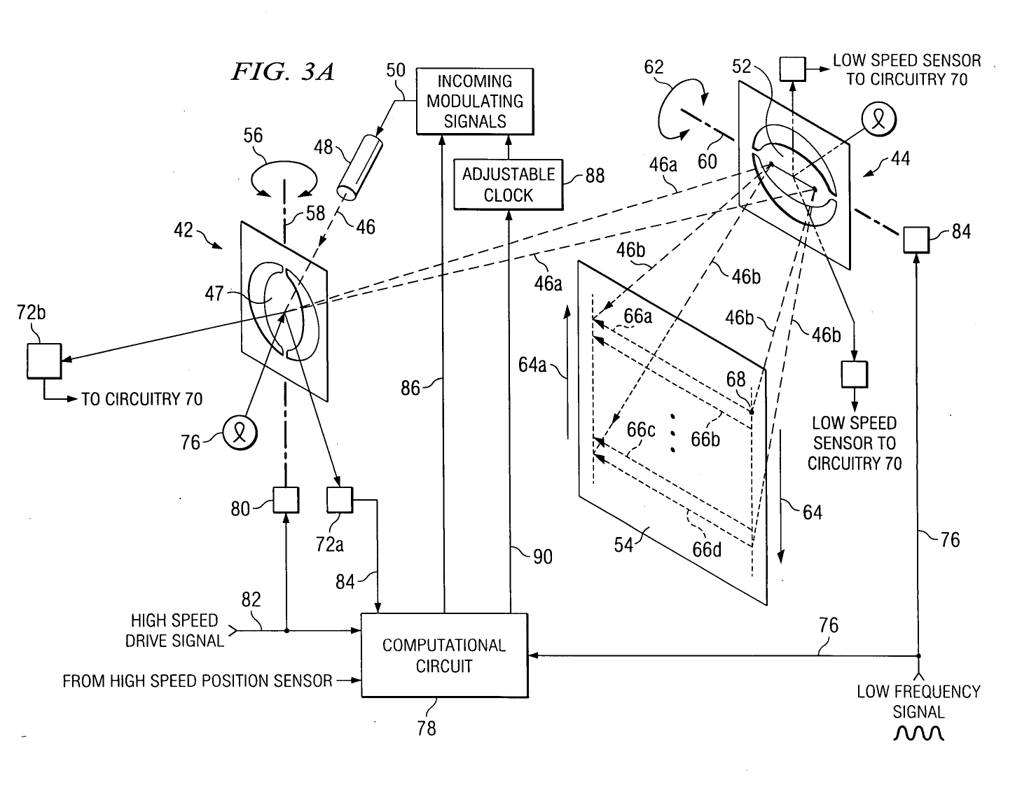

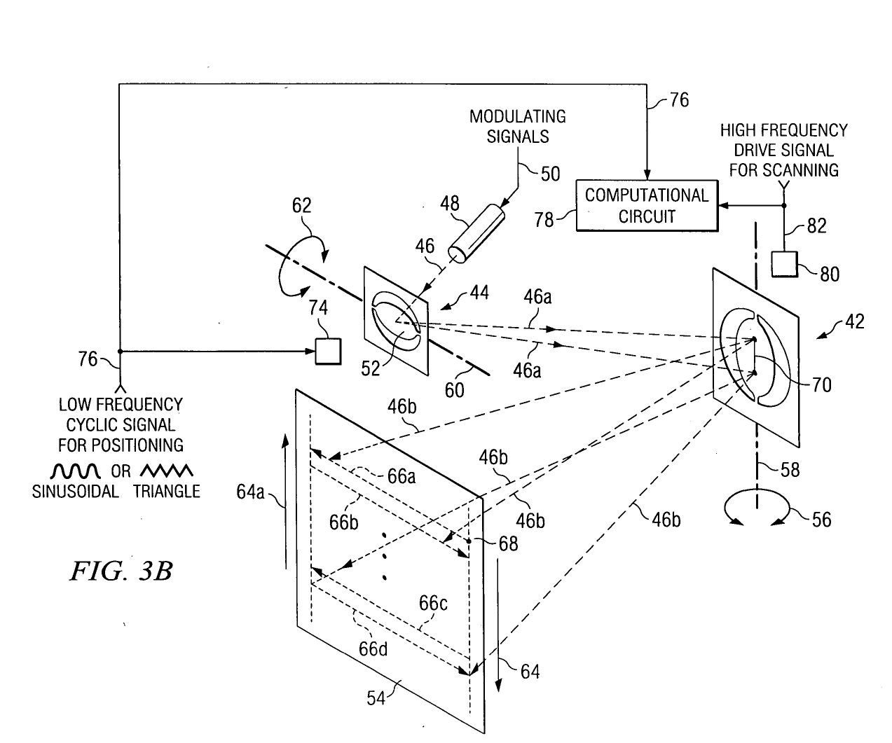

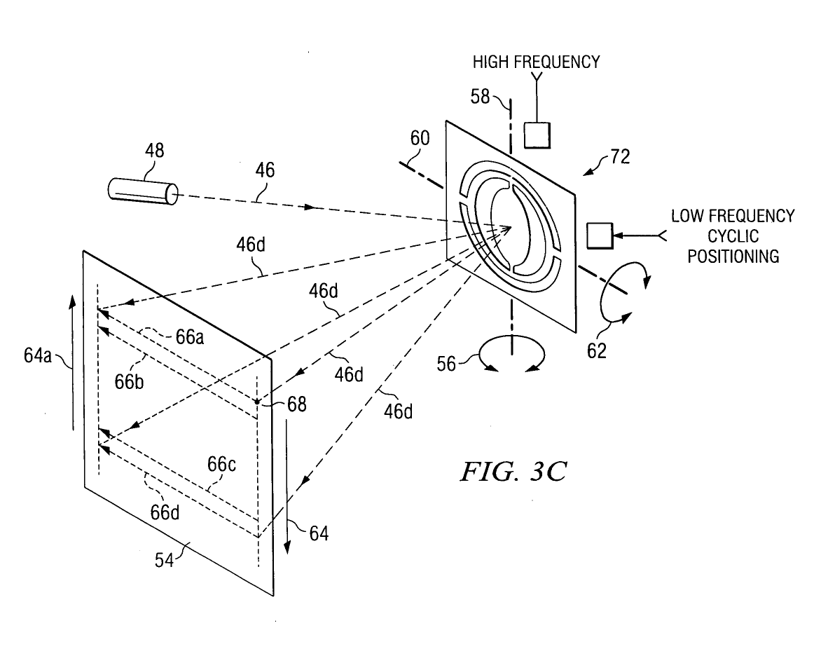

Referring now to FIG. 3A, there is a perspective illustration of an embodiment of the present invention as used in a visual display that uses two single axis separate mirrors that pivot about their torsional hinges. As shown, a high frequency or scanning single axis torsional hinged mirror 42 may be used in combination with a low frequency or positioning single axis torsional hinged mirror 44 to provide a raster scan. A light beam 46 from a source 48 is modulated by incoming signals on line 50 to generate pixels that comprise the scan lines. The modulated light beam 46 impinges on surface 47 of the high frequency resonant mirror 42 and is reflected as sweeping light beam 46a to the reflecting surface 47 of the low frequency positioning mirror 44. Positioning mirror 44 redirects the modulated light beam 46b to a display surface 54, which may be a screen or light sensitive printer medium. The oscillations of the high frequency scanning mirror 42 (as indicated by arcuate arrow 56) around pivot axis 58 results in light beam 46b (the scan lines) sweeping across the display surface 54, whereas the oscillation of the positioning mirror 44 about axis 60 (as indicated by double headed arrow 62) results in the scan lines being positioned vertically (or orthogonally to the scan lines) on the display surface 54. It is again noted that the terms horizontal and vertical are for explanation purposes only. Therefore, since the scanning motion of light beam 46b across display surface 54 may occur several hundred or even a thousand times during the orthogonal movement in one direction of the low speed positioning mirror 44, as indicated by arrow 64, a raster scan type image can be generated or printed on display surface 54 as indicated by image lines 66a, 66b, 66c, and 66d. The light beam 46b often paints another image in the reverse direction as indicated by arrow 64a, and returns to the starting point 68.

Referring to FIG. 3B, there is a perspective illustration of another embodiment of the present invention using two single axis separate mirrors that pivot about their torsional hinges. In this arrangement and contrary to the embodiment of FIG. 3A, the modulated beam is reflected from the positioning mirror 44 to the scanning mirror. As shown, light beam 46 from source 48 is modulated by incoming video signals on line 50 as was discussed above, and impinges on the low frequency positioning mirror 44 rather than the high speed scanning mirror 42. The modulated light beam 46 is then reflected off of mirror 44 to the reflecting surface 47 of the high frequency oscillation or scanning mirror 42. Mirror 42 redirects the modulated light beam 46b to display surface 54. The oscillations (as indicated by arcuate arrow 56) of the scanning mirror 42 about axis 58 still results in light beam 46b or the scan lines sweeping horizontally across display surface 54, whereas the oscillation of the positioning mirror 44 still results in the scan lines being positioned vertically on the display surface.

That is, oscillations of the positioning mirror 44 about axis 60 as indicated by double headed arcuate arrow 62 still moves the reflected modulated light beam 46a with respect to scanning mirror 42 such that the light beam 46a moves orthogonally to the scanning motion of the light beam as indicated by line 70 in the middle of the reflecting surface of scanning mirror 42. Thus, it will be appreciated that in the same manner as discussed above with respect to FIG. 3A the high frequency scanning motion of the light beam 46b as indicated by image lines 66a, 66b, 66c, and 66d on display screen 54 will still occur several hundred or even a thousand times during a single orthogonal movement of the low frequency positioning mirror 44. Therefore, as was the case with the embodiment of FIG. 3A, a raster scan type visual display can be generated or painted on display surface 54 in a single direction as indicated by arrow 64, or in both directions as indicated by arrow 64 and 64a.

The above discussion with respect to FIGS. 3A and 3B is based on two single axis torsional hinged mirrors. However, as will be appreciated by those skilled in the art, a single dual axis torsional hinged mirror, such as mirror structure 72 shown in FIG. 3C may be used to provide both the high frequency scanning motion about axis 58 as indicated by arcuate arrow 56, and the positioning or orthogonal motion about axis 60 as indicated by arcuate arrow 62, in the same manner as the oscillation of the individual mirrors 42 and 44 discussed in the embodiment of FIGS. 1A and 1B. The remaining elements of FIG. 3C operate the same as in FIGS. 3A and 3B and consequently carry the same reference number. It should also be noted, however, that the modulated light beam is only reflected one time and, therefore, the reflected beam carries reference number 46d.

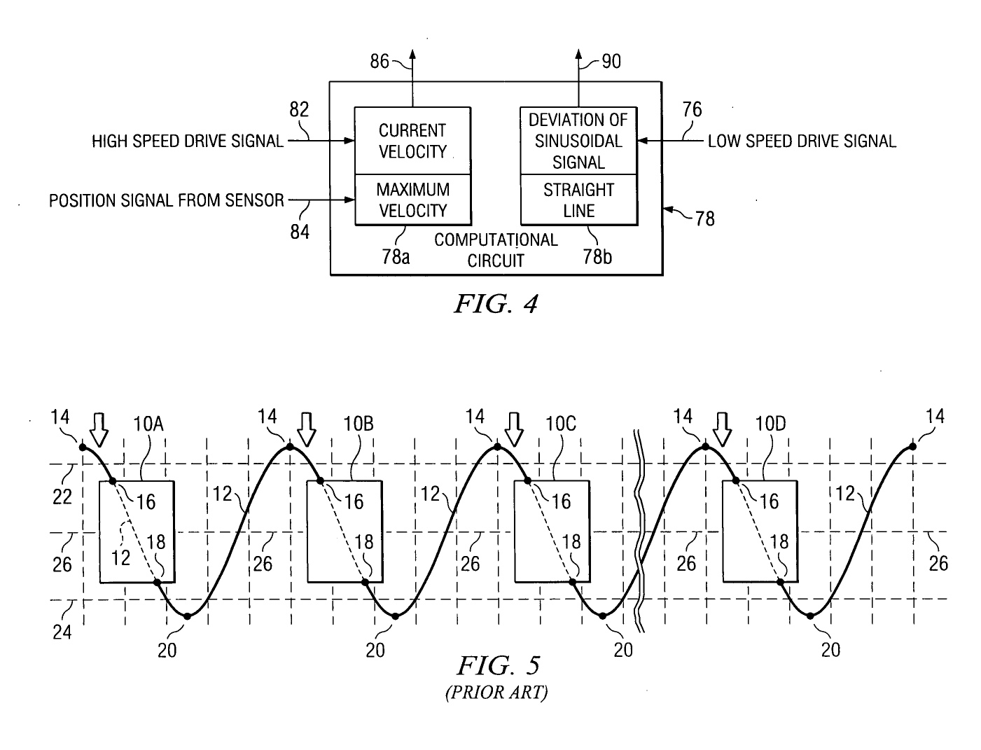

However, as was discussed above, if a greater portion of a mirror beam sweep is to be used, there needs to be compensation for the image compression and increased light intensity. Therefore, referring again to FIG. 3A, there is included a low speed drive circuit 74 for positioning the scan lines. Low speed drive circuit 74 receives a drive signal on line 76, which is also provided to computational circuitry 78. Similarly, the scan lines are generated by a high frequency drive circuit 80 in response to a high frequency signal on line 82, which is also provided to computational circuitry 78. Referring now to FIG. 4, and as discussed above, computational circuitry 78 receives both the low frequency and high frequency drive signals on lines 76 and 82 respectively. Consequently, the angular velocity and position of the low speed positioning mirror 44 can be calculated or inferred at every position of its sinusoidal travel. It should further be appreciated that although FIG. 4 illustrates subcircuits in computational circuitry 78, the calculations are typically accomplished in software.

However, as will be appreciated by those skilled in the art, the position of the high speed resonant mirror cannot be accurately calculated from just the input drive signal. Therefore, the actual positions of the high speed mirror are determined by sensors and a signal on line 84 indicative of the high speed mirror being at a known angular position. The signal on line 84 is received by computational circuitry 78. Knowing when the scanning mirror is at one or more angular positions along with the known oscillating frequency of the mirror, which is determined by the drive signal, allows all positions of the scanning mirror to be accurately calculated.

Therefore, the intensity parameter of the appropriate pixel at each known location can be adjusted as a function of the velocity of one or both of the positioning mirror and/or scanning mirror by computational circuitry 78. Therefore, as shown, an adjustment signal is provided on line 86 to adjust the intensity signal that controls the laser beam. More specifically, as the individual pixels and individual scan lines are displayed closer and closer together, as the scanning mirror and positioning mirror respectively slow down, a corresponding reduction of the light intensity would in turn reduce or eliminate the halo or frame of light around the image (see FIG. 2). It should also be appreciated that intensity adjustment, based on the motion of the scanning mirror, is with respect to individual pixels; whereas an intensity adjustment based on the motion of the slower positioning mirror affects all of the pixels comprising an image line. The required signal to make this adjustment may be determined in computational circuitry 78 by multiplying the intensity of the laser by a factor related to current velocity and the maximum velocity of the sweeping light beam as indicated by circuit 78a.

Similarly, according to existing systems, the individual pixels for a scan line are delivered or distributed for display to the screen or printer medium at a constant rate. However, by modifying the clocking signals from clock circuit 88 for each pixel to be displayed in response to a signal on line 90, the output rate at the edges of the image can be slowed down so that the pixels are not so close together. Further, since the movement of the mirror is sinusoidal, the clock adjusting signal on line 90 that controls the amount of slowing of the pixel output clock 80 can be calculated by circuit 78b to be a value proportional to the deviation of the sinusoidal drive of the high speed scanning mirror to a straight line. This adjustment will help eliminate the compression effect resulting as the high speed scanning mirror slows down as it approaches edges 39 and 41 of FIG. 2B As mentioned above, this embodiment of adjusting clock speed is not suitable for the low speed mirror since the individual scan lines are synchronized with incoming scan line signals.

Furthermore, because these changes will be synchronous with the drive signal waveforms, these changes can be pre-computed to reduce the overhead required for the computations.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. In an imaging system comprising an oscillating mirror for reflecting a modulated beam of light to generate a series of image lines that form an image, a method for improving the quality of the image comprising the steps of:
oscillating said mirror at a selected frequency;
directing a beam of light towards said oscillating mirror such that said beam of light is received at a display surface;
storing a series of signals representing at least one image line of said image, said signals defining selected parameters of pixels forming said image line and wherein one of said selected parameters is the intensity of said pixels;
adjusting said intensity parameter of said stored signals as a function of the velocity of said oscillating mirror; and
outputting said series of stored signals and modulating said beam of light directed towards said mirror with said series of signals including signals having an adjusted intensity parameter.

2. The method of claim 1 wherein outputting said series of signals is in response to a clocking signal and further comprising continuously scaling said clocking signal as a function of the sinusoidal motion of the oscillating mirror to a straight line motion to provide a proportional image.

3. The method of claim 1 wherein said oscillating mirror is a scanning mirror.

4. The method of claim 3 wherein said imaging system is a printer.

5. The method of claim 4 wherein said image lines are generated during both the forward and reverse scanning motion of said scanning mirror.

6. The method of claim 3 wherein said imaging system is a visual display.

7. The method of claim 6 wherein said image lines are generated during both the forward and reverse scanning motion of said scanning mirror.

8. The method of claim 6 further comprising oscillating a second mirror at a speed slower than the speed of said scanning mirror to provide orthogonal motion to said beam of light.

9. The method of claim 8 wherein said step of adjusting the intensity parameter of said stored signals comprises the step of adjusting the intensity parameter as a function of the velocity of both of said oscillating mirrors.

10. The method of claim 6 wherein said oscillating mirror is a dual axis mirror and wherein motion of said mirrors around one of said dual is orthogonal to motion around the other one of said dual axis.

11. The method of claim 1 wherein said step of adjusting said intensity parameter comprises calculating and generating an adjusting signal for selected ones of said series of signals, said adjusting signal calculated as the ratio of the velocity of the oscillating mirror to the maximum velocity attained by the oscillating mirror and using said adjusting signal to adjust the intensity parameter of said selected ones of said series of signals.

12. The method of claim 11 wherein the calculations for said adjusting signal are computed and stored until needed.

13. The method of claim 1 wherein said oscillating mirror is a resonant oscillating mirror.

14. The method of claim 1 wherein said oscillating mirror is a torsional hinged mirror.

15. In an imaging system comprising a scanning mirror for reflecting a modulated beam of light to generate a series of image lines that form an image, a method for improving the quality of the image comprising the steps of:
oscillating said scanning mirror at a selected frequency;
directing a beam of light towards said oscillating mirror such that said beam of light is received at a display surface;
storing a series of signals defining selected parameters of pixels comprising at least one of said scan lines;
generating a clocking signal that varies as a function of the sinusoidal motion of the oscillating mirror;
outputting said series of stored signals in response to said varying clocking signal; and
modulating said beam of light directed toward said oscillating mirror with said outputted series of signals to generate a proportional image.

16. The method of claim 15 wherein said image lines are generated in both the forward and reverse scan motion of said scanning mirror.

17. The method of claim 15 wherein said imaging system is a printer.

18. The method of claim 15 wherein said system is a visual display.

19. The method of claim 18 further comprising a slow speed oscillating mirror for providing orthogonal motion to said beam of light.

20. The method of claim 18 wherein said scanning mirror is a dual axis mirror and wherein one of said axis provides motion orthogonal to said scanning motion.

21. The method of claim 5 wherein said clocking signal varies as a function of the sinusoidal motion of the scanning mirror to linear or straight line motion.

22. The method of claim 19 wherein said step of adjusting the intensity parameter of said stored signals comprises the step of adjusting the intensity parameter as a function of the velocity of both of said oscillating mirrors.
